(19) United States
(12) Patent Application Publication
(10) Pub. No.: US 2002/0115318 A1
(43) Pub. Date: Aug. 22, 2002

(54) Electrical connector and circuit with center ground plane

(76) Inventor: Samuel W. Apicelli, Camp Hill, PA (US)

Correspondence Address: SAMUEL W. APICELLI, DUANE MORRIS LLP, 305 NORTH FRONT STREET, P.O. BOX 1003, HARRISBURG, PA, 17108-1003, US

(21) Appl. No.: 10/035,079

(22) Filed: Dec. 28, 2001

Related U.S. Application Data
(60) Provisional application No. 60/259,602, filed on Jan. 2, 2001.

(51) Int. Cl. H01R 4/66

(52) U.S. Cl. 439/108

(57) ABSTRACT

A connector assembly is provided having signal contacts and a ground plane mounted within a housing. The ground plane includes a plurality of spring contacts positioned along one edge and adapted to cooperatively engage a conductive edge surface of a printed circuit board ground plane without penetrating or extending into the edge of the printed circuit board.

This application claims priority from co-pending provisional patent application Serial No. 60/259,602, filed Jan. 2, 2001.

### FIELD OF THE INVENTION

The invention is generally related to electrical connectors which are mounted on a printed circuit board, and more particularly to an electrical connector which has surface mount terminals and resilient terminals which extend from a mating surface thereof.

### BACKGROUND OF THE INVENTION

Electrical connectors that are mounted to a printed circuit board are well known in the art. As the size of the electronic devices in which the printed circuit boards are installed has decreased, the density of the connectors positioned on those boards has increased. Such electronic devices also require electrical connectors with numerous terminals be mounted on a printed circuit board in such a manner as to occupy a minimal area of printed circuit board real estate.

In order to provide for a higher density of connectors on printed circuit board, surface mount technology was utilized. With surface mounting, the conductive pads on the printed circuit board can be closely spaced, thereby allowing more contacts to be mounted in the same area of the board. As the density of the connectors on the printed circuit board increases, the length of the terminals cannot increase significantly without degrading the electrical performance of the electronic device. This is particularly true in electronic devices designed for high speed applications. Typically, high density connectors which have the shortest path over which the signals must travel operate optimally. As the density of interconnects increases, and the pitch between contacts approaches 0.5 mm or less, the close proximity of the terminal contacts increases the likelihood of strong electrical cross-talk coupling between the terminal contacts. In addition, maintaining design control over the electrical characteristic impedance of the terminal contacts becomes increasingly difficult.

Modern electronics requires the use of high frequency and high speed connectors particularly for use in interconnecting circuitry on motherboards or backplanes and daughter cards or other circuit devices. These connectors require shielding or ground planes between the signal pins; e.g., stripline configuration, to provide high frequency signal integrity and minimize interference from outside sources. U.S. Pat. No. 4,975,084 discloses one such system provided with ground contacts between columns of signal contacts, the ground contacts of one connector having projecting blades and the mating ground contacts of the other connector including plates with cantilevered beams. The plates provide a shield between the columns of mated signal contacts and the cantilevered beams engage the blades to complete the ground circuits. The ground contacts of this connector are disposed within slots extending from the sidewall and partially across the respective housings and the connector includes an array of power, signal and ground contacts. This arrangement requires an amount of dielectric housing material to insulate between the adjacent contacts and to isolate the various circuits. For some applications, it is desirable to have a more highly dense array or grid of contact members, while maintaining the integrity between the lines. As the center line spacing between contact members in a row is decreased, the spacing between adjacent columns of contact members is likewise decreased, thereby necessarily reducing the amount of dielectric housing material between the members of the array. This in turn affects the electrical characteristics of the connector system and in particular reduces the impedance through the connector system. It is desirable, therefore, to have an electrical connector that provides a more dense array of contact members while maintaining the electrical characteristics associated with connectors having a less dense array of contact members.

Though there are many types of connectors available, it would be desirable to have a connector with a precisely controlled impedance to reduce signal reflections. It would also be desirable to have a connector which could accommodate fast signals, those with rise times on the order of 250 psec or less. Such a connector should also be durable while at the same time being detachable so that printed circuit boards can be joined and separated during use.

### SUMMARY OF THE INVENTION

The present invention provides an electrical connection between an electrical connector and an edge surface of a substrate. In order to accomplish this, spring contacts are formed on or adjacent to a mating edge of an electrical ground plane portion of an electrical connector so as to be in position to electrically and mechanically engage the edge surface of the substrate, but without penetrating that edge surface. Thus in one embodiment, a connector assembly is provided that has signal contacts and a ground plane mounted within a housing. The ground plane includes a plurality of spring contacts positioned along one edge and arranged so as to electrically engage only a conductive edge surface of a printed circuit board ground plane.

The invention is also directed to an electrical connector adapted to electrically engage a printed circuit board ground plane having a portion exposed at the edge surface of the printed circuit board and to a connector assembly. The connector assembly has a housing with first and second terminals. The first and second terminals have first and second mounting portions, respectively, which cooperate with a printed circuit board provided proximate the housing. The printed circuit board has conductive areas provided on top and bottom surfaces, and on at least one of the peripheral edge surfaces that extend between the top and bottom surfaces.

The first terminals are secured in the housing, with first securing portions of the first terminals provided in first terminal receiving cavities. The first mounting portions are integral with the first securing portions and extend outside the housing, so as to allow the first mounting portions to cooperate with the conductive areas provided on the top and bottom surfaces of the printed circuit board. The second terminals are also secured in the housing, with second securing portions of the second terminals provided in second terminal receiving cavities. The second mounting portions are integral with the second securing portions and extend outside the housing, so as to allow the second mounting portions to cooperate with the at least one conductive area located on the peripheral edge surfaces that extend between the top and bottom surfaces.

The at least one conductive area located on the peripheral edge surfaces of the printed circuit board is positioned proximate an edge surface of the printed circuit board. The second mounting portions comprise a biasable structure, e.g., a spring structure. The biasable structure cooperates with the edge surface of the substrate to allow the second mounting portions to electrically and mechanically engage the conductive area proximate to the edge surface of the substrate without projecting into or extending through an edge surface of the printed circuit board.

An electrical circuit assembly is also provided that includes a printed circuit board having at least one conductive grounding plane positioned below opposing top and bottom surfaces. The at least one conductive grounding plane is constructed so as to electrically communicate with at least one conductive edge surface that is accessible at a peripheral edge surface of the printed circuit board that extends between the opposing top and bottom surfaces. A connector is assembled to the printed circuit baord that comprises signal contacts and a ground plane mounted within a housing. The ground plane of the connector includes a plurality of spring contacts positioned along one edge that are arranged so as to electrically engage the at least one conductive edge surface of the at least one conductive grounding plane of the printed circuit board.

### BRIEF DESCRIPTION OF THE DRAWINGS

These and other features and advantages of the present invention will be more fully disclosed in, or rendered obvious by, the following detailed description of the preferred embodiment of the invention, which is to be considered together with the accompanying drawings wherein like numbers refer to like parts and further wherein:

FIG. 1 is a perspective view of a connector assembly formed in accordance with the present invention;

FIG. 2 is an exploded perspective view of the connector assembly of FIG. 1, showing a first connector housing, a second connector housing, and a bus bar ground plane;

FIG. 3 is a partial cross-sectional view of the connector housings shown in FIG. 2, the bus bar ground plane of FIG. 2 is positioned in the first connector housing;

FIG. 4 is a partial cross-sectional view of the connector housings, similar to that shown in FIG. 3, with the connector housings mated together;

FIG. 5 is a cross-sectional view of the connector housings prior to connector housings being mated with each other;

FIG. 6 is a cross-sectional view of the connector housings, similar to that of FIG. 5, showing the connector housings in a mated condition;

FIG. 7 is a cross-sectional view of the connector housings, taken in a different plane than the cross-sectional view of FIG. 6, showing the connector housings in a mated condition;

FIG. 8 is a top perspective view of the first connector housing, before the first connector housing has been positioned on the edge of the first printed circuit board;

FIG. 9 is a bottom perspective view of the first connector housing, before the first connector housing has been positioned on the edge of the first printed circuit board;

FIG. 10 is a top perspective view of the second connector housing with terminals exploded therefrom, before the second connector housing has been positioned on the surface of the second printed circuit board;

FIG. 11 is a bottom perspective view of the second connector housing, before the second connector housing has been positioned on the surface of the second printed circuit board; and

FIGS. 12-15 are each a perspective, partially broken-away view of the first printed circuit board illustrating the positioning of alternative biasable members of a bus bar ground plane relative to the conductive edge surface of the first printed circuit board.

### DETAILED DESCRIPTION OF THE PREFERRED EMBODIMENT

This description of preferred embodiments is intended to be read in connection with the accompanying drawings, which are to be considered part of the entire written description of this invention. The drawing figures are not necessarily to scale and certain features of the invention may be shown exaggerated in scale or in somewhat schematic form in the interest of clarity and conciseness. In the description, relative terms such as “horizontal,” “vertical,” “up,” “down,” “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship. In the claims, means-plus-function clauses are intended to cover the structures described, suggested, or rendered obvious by the written description or drawings for performing the recited function, including not only structural equivalents but also equivalent structures.

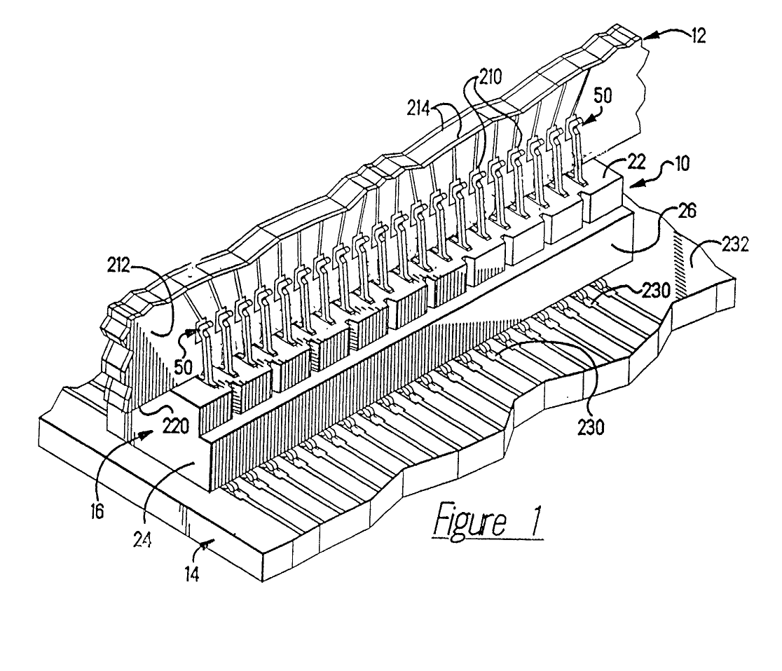

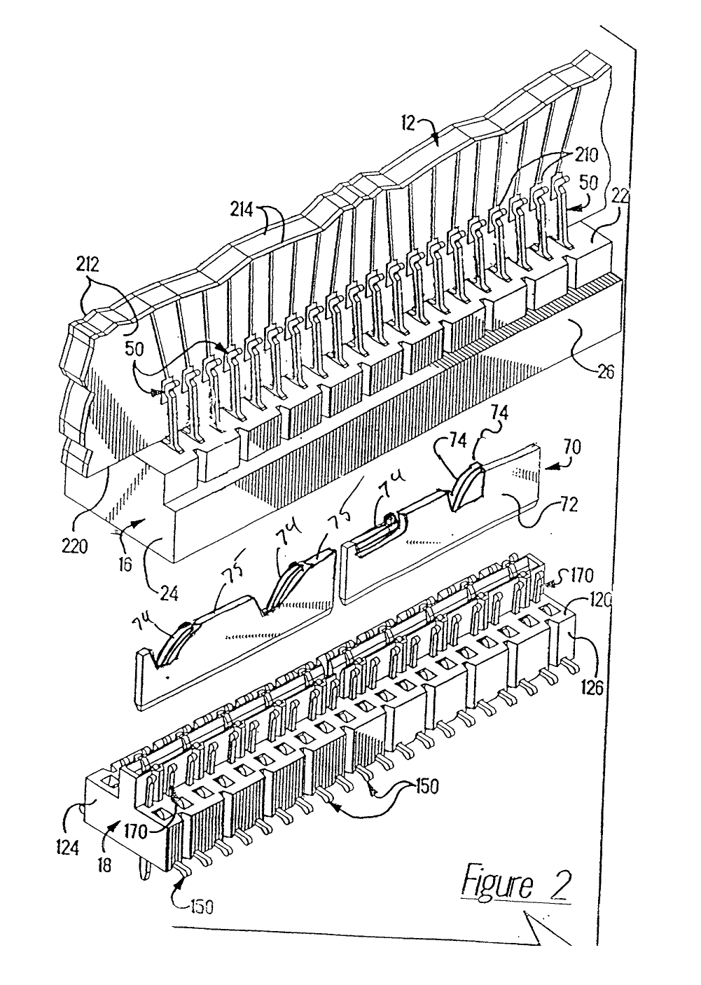

Referring to FIGS. 1 and 2, an electrical connector assembly 10 formed in accordance with the present invention provides electrical connection between a first circuit board 12 and a second circuit board 14. Connector assembly 10 has a first connector housing 16 and a second connector housing 18.

More particularly, first connector housing 16 includes a first or mating surface 20 and an oppositely facing second or terminal receiving surface 22. End walls 24 and side walls 26 extend between mating surface 20 and terminal receiving surface 22. Side walls 26 have transition portions 28, since mating surface 20 is larger than terminal receiving surface 22. A mating connector receiving recess 30 extends from mating surface 20 toward terminal receiving surface 22. Mating connector receiving recess 30 is dimensioned to be positioned proximate end walls 24 and proximate side walls 26.

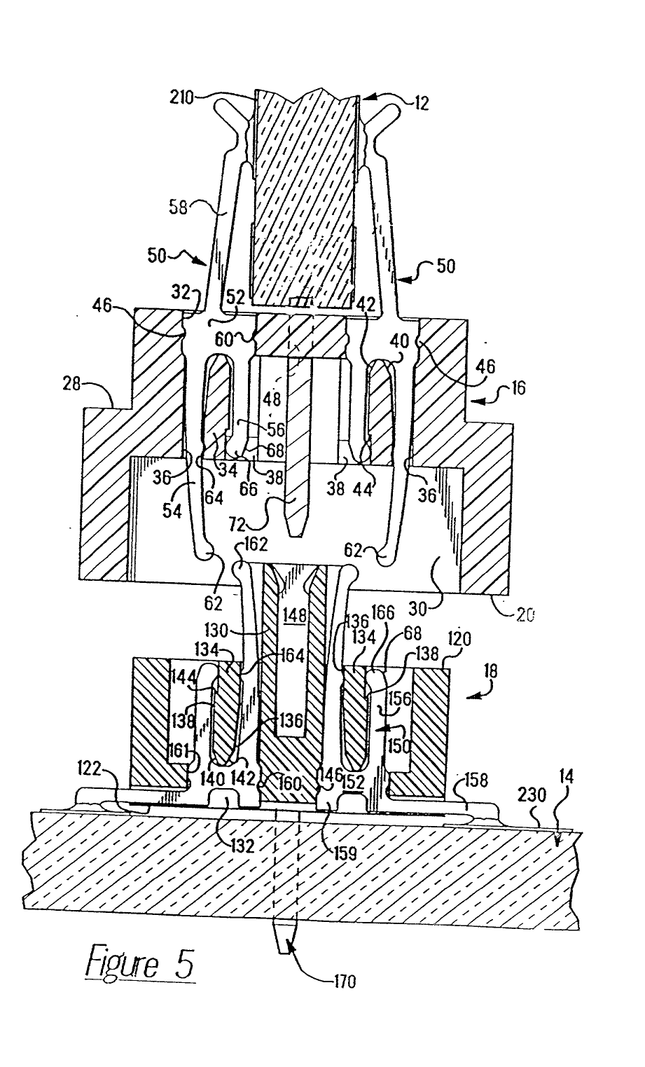

Terminal receiving cavities 32 are provided in first connector housing 16 and extend from terminal receiving surface 22 to mating connector receiving recess 30. As best shown in FIG. 5, terminal receiving cavities 32 are provided on both sides of the longitudinal axis of first connector housing 16. Terminal receiving cavities 32, that are provided on a respective side of the axis, are mirror images of the terminal receiving cavities provided on the opposite side of the axis. Referring to FIG. 5, terminal receiving cavities 32 have dividing walls 34 which separate the terminal receiving cavities into two portions, first leg receiving cavities 36 and second leg receiving cavities 38. Dividing walls have lead-in surfaces 40, 42 which are provided proximate terminal receiving surface 22. Shoulders 44 are provided on dividing walls 34 on surfaces of the dividing walls which are positioned proximate second leg receiving cavities 38. Securing projections 46 are also provided in terminal receiving cavities 32.

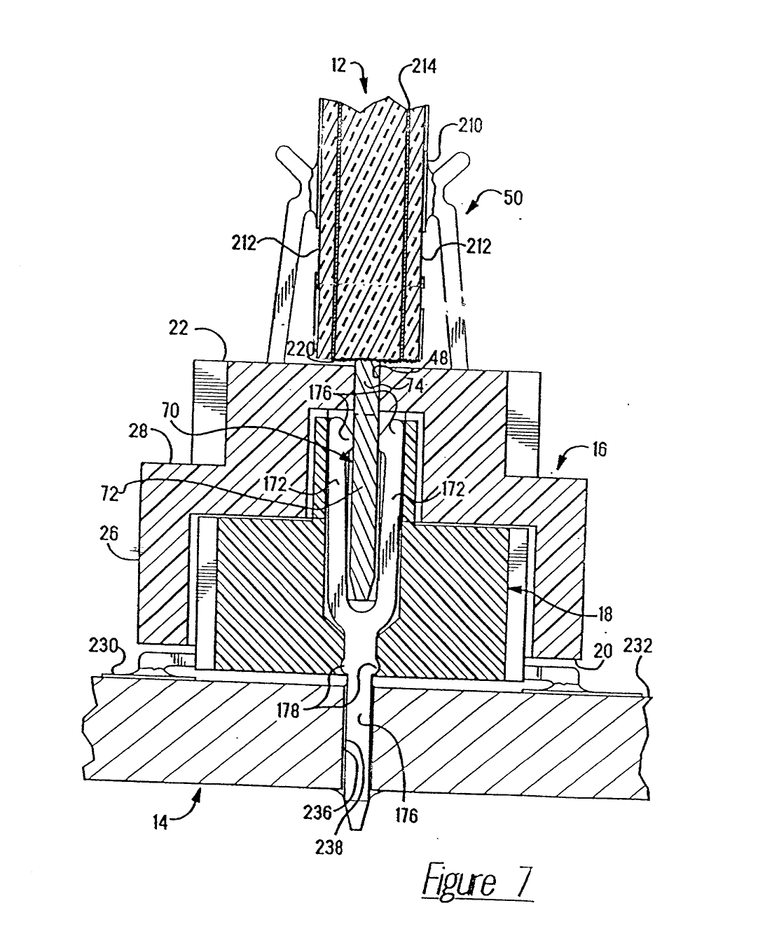

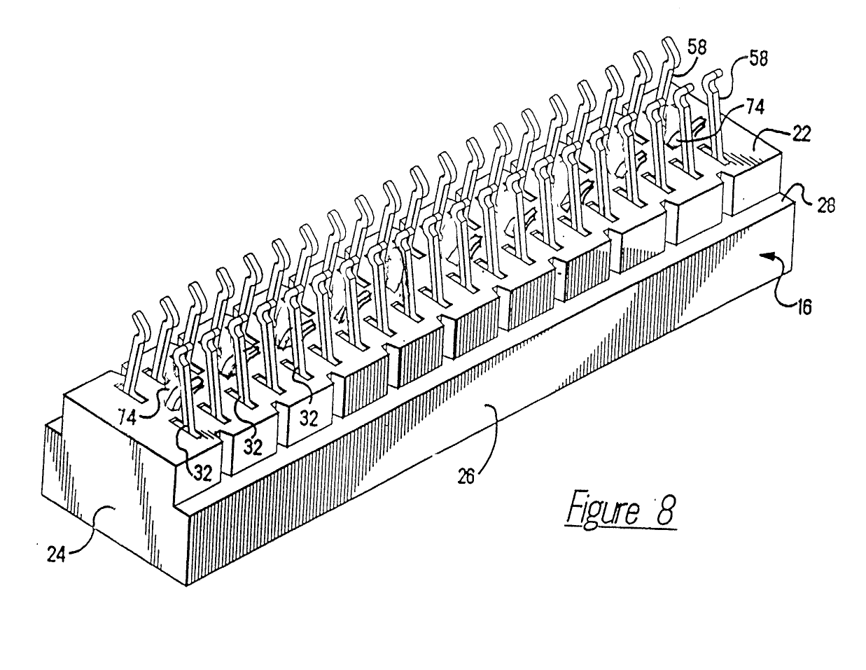

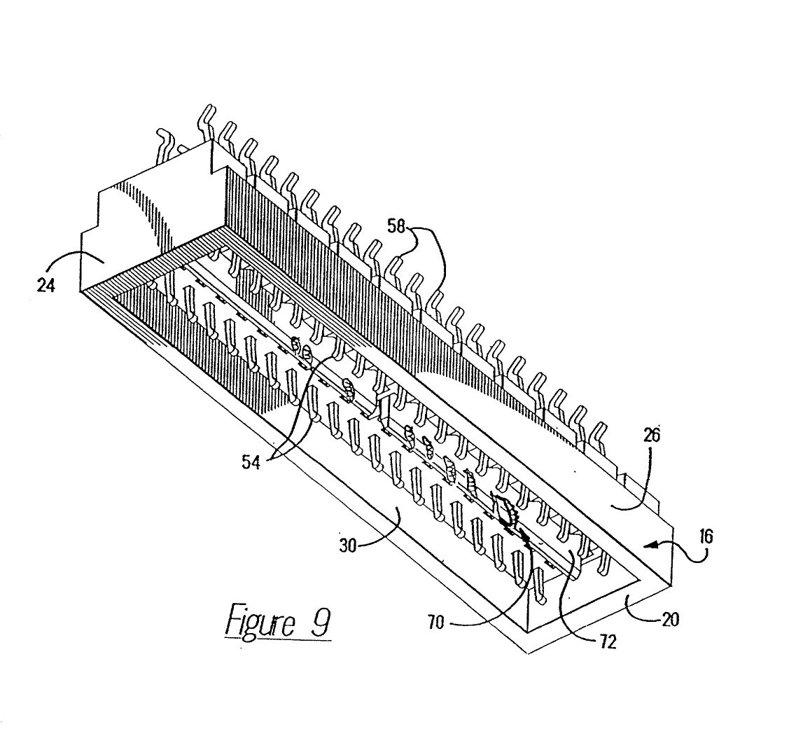

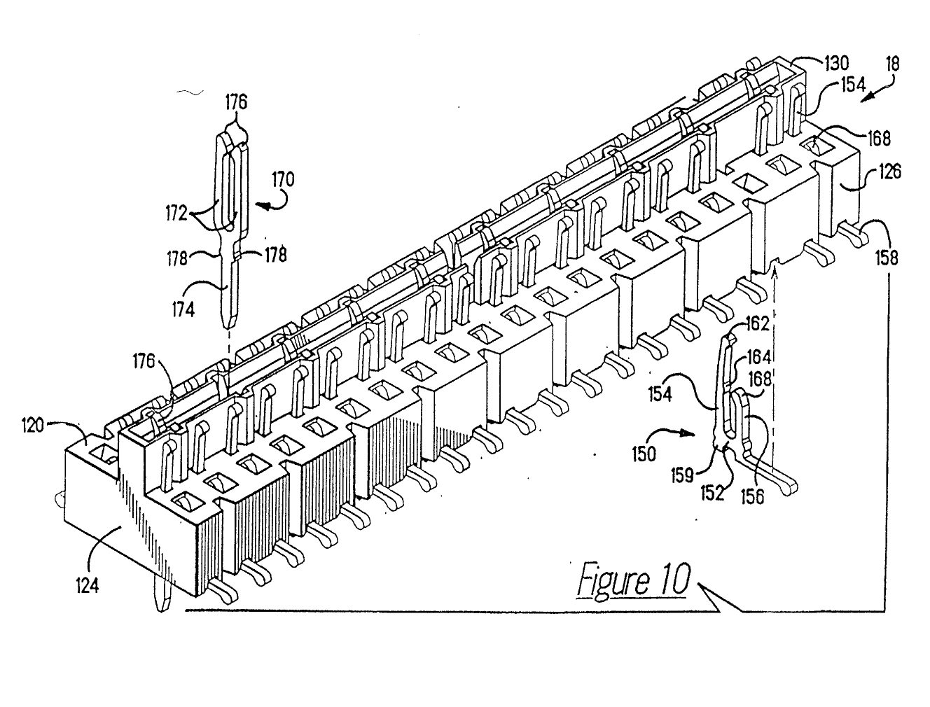

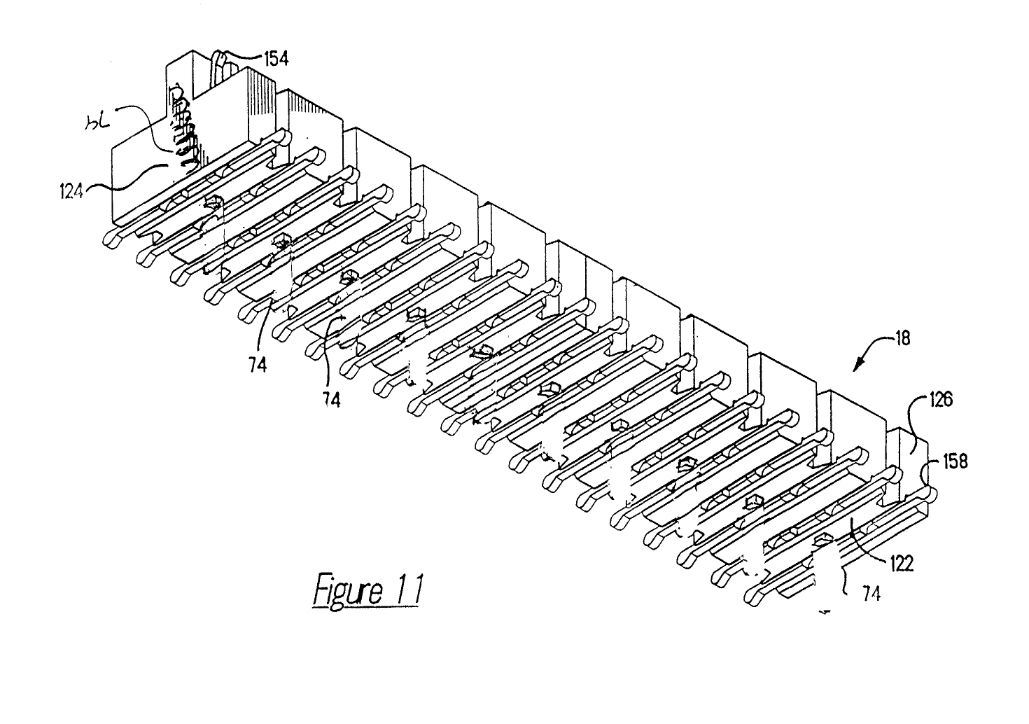

Bus bar receiving recesses 48 (FIGS. 5 and 7) are provided in first connector housing 16. Bus bar receiving recesses 48 extend from mating connector receiving recess to terminal receiving surface 22. First connector terminals 50 (FIG. 50 have mounting portions 52. First legs 54 and second legs 56 extend from mounting portions 52 in essentially the same direction, thereby enabling first and second legs 54, 56 to be mated with the mating connector. Printed circuit board mating legs 58 extend from mounting portions 52 in a direction which is opposed to first and second legs 54, 56.

Mounting portions 52 have recesses 60 provided on side surfaces. Recesses cooperate with securing projections 46 to provide the interference fit required to maintain terminals 50 in terminal receiving cavities 32. It should be noted that end surfaces of dividing walls 34 also cooperate with surfaces of mounting portions 52 to ensure that terminals 50 are properly positioned. First legs 54 have a slightly arcuate configuration. Free ends of first legs have enlarged contact sections 62 which extend beyond first leg receiving cavities 36 and into mating connector receiving recess 30. Enlarged positioning sections 64 are also provided on first legs 54. Positioning sections 64 cooperate with dividing walls 34 when the first legs are in an unmated condition. It is important to note that first leg receiving cavities 36 are dimensioned to receive first legs 54, thereby allowing the first legs to move from an unmated or slightly prestressed position to a mated position.

Second legs 56 are positioned in second leg receiving cavities 38. Unlike the first legs, second legs 56 do not extend into mating connector receiving recess 30. Free ends 66 of second legs 56 are provided at an angle relative to the second legs. This allows the free ends 66 to engage dividing walls 34. Lead-in surfaces 68 are provided at free ends 66 of second legs 56.

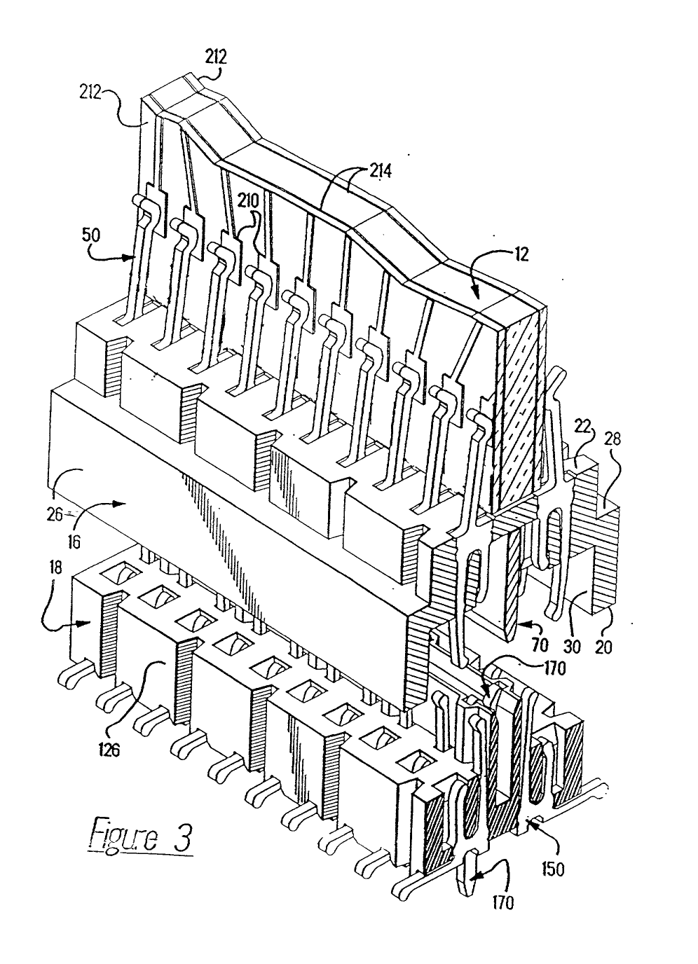

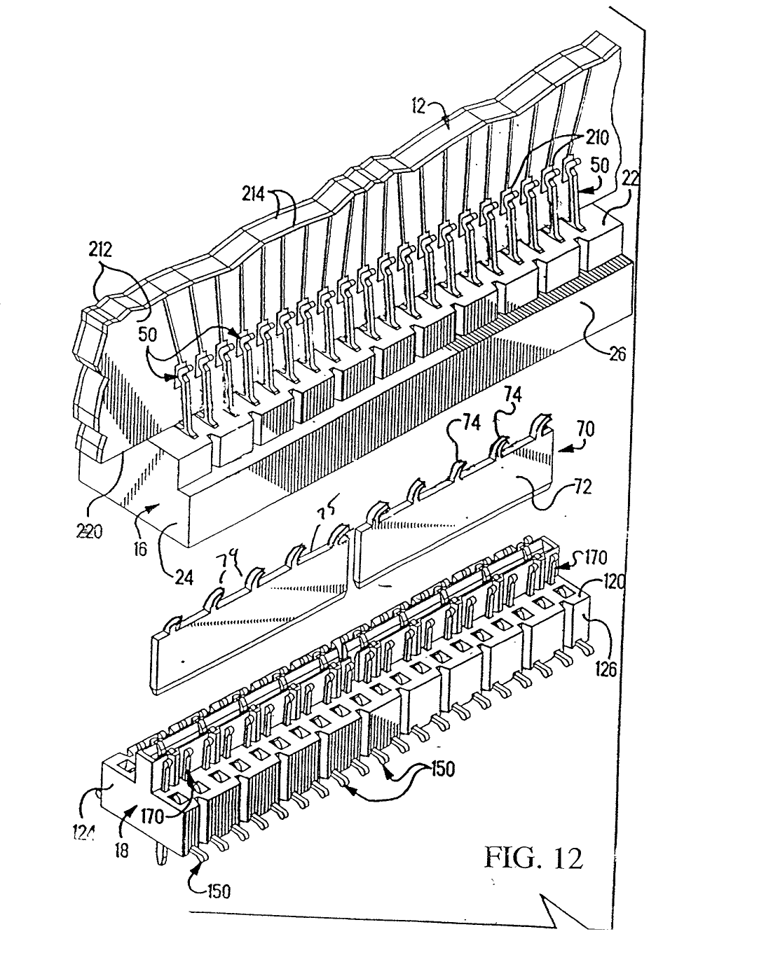

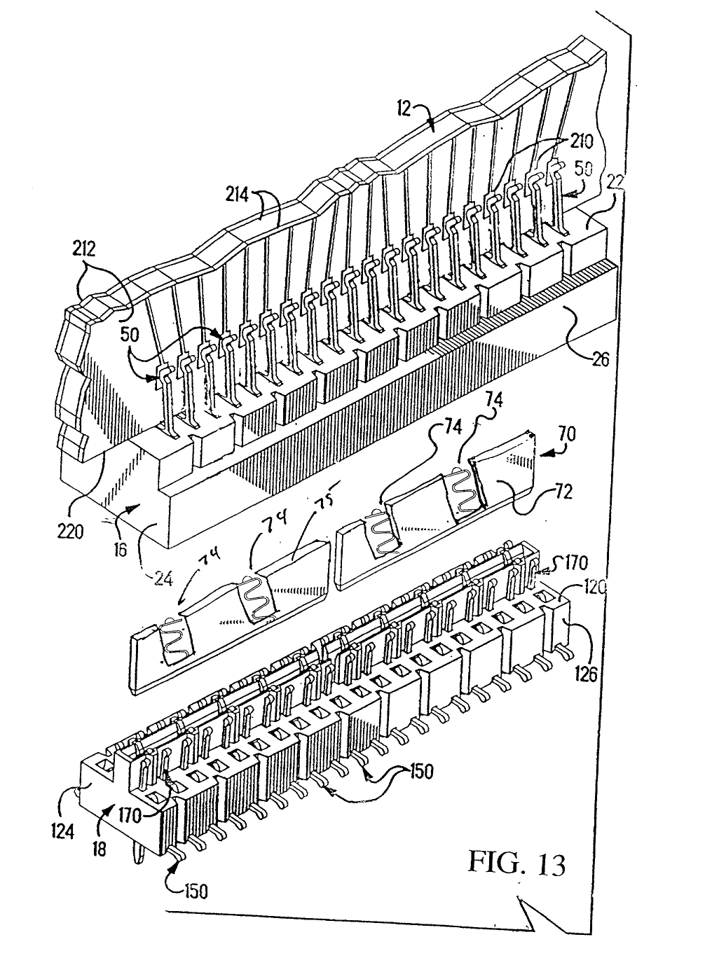

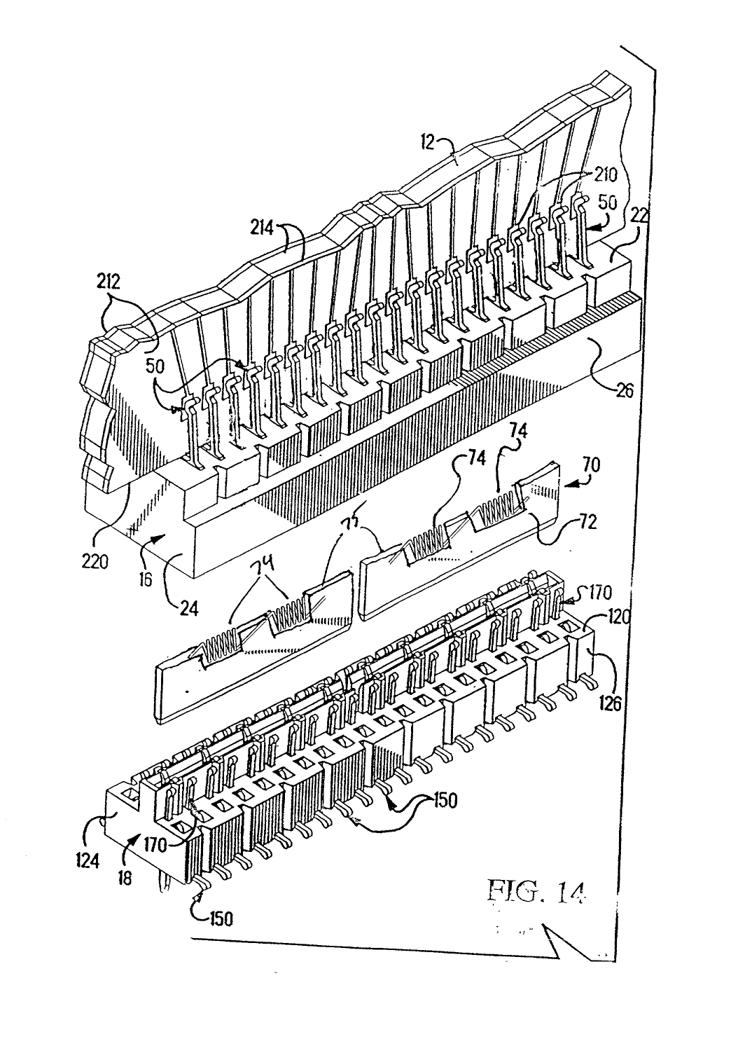

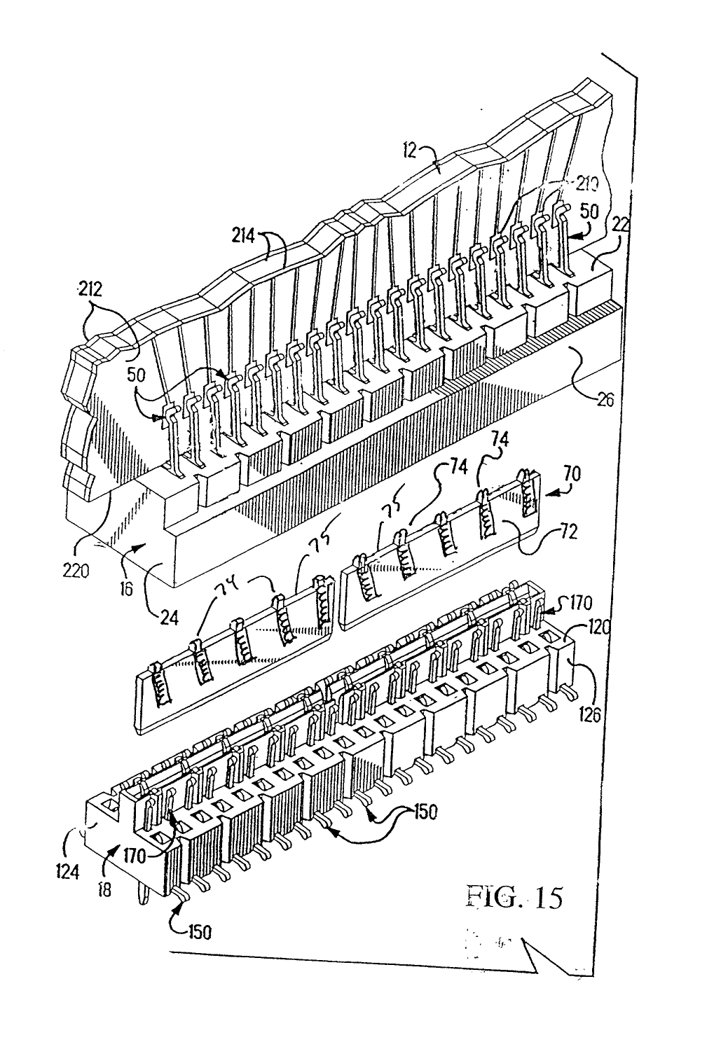

Bus bar ground planes 70 are positioned in first connector housing 16. Bus bars 70 preferably have connector mating portions 72 and biasable structures 74 positioned along or adjacent to a free edge 75. Connector mating portions 72 extend from receiving recesses 48 into mating connector receiving recess 30. Biasable structures 74 may comprise various spring configurations (FIGS. 12-15) either formed integral with free edge 75 or fastened to bus bar 70 adjacent to free edge 75 so as to be engagable with a conductive side edge (shown generally at 220) of a printed circuit board. It will be understood that conductive side edge 220 extends between opposing top and bottom surfaces 212 so as to intersect surfaces 212, but is not coplanar with surfaces 212. Side edge 220 may be electroplated so as to present a generally flat, conductive surface for engagement with biasable structures 74, but without biasable structures 74 entering the circuit board edge. Conductive side edge 220 is disposed and structurally arranged so as to be in electrical communication with conductive grounding planes 214 that are positioned below opposing top and bottom surfaces 212 (FIG. 3).

Biasable structures 74 may comprise one or more cantilever, compression, or straight or canted coil springs that have been separately or integrally formed along free edge 75 of bus bar ground plane 70, or may be a combination of compression spring and contact that are arranged on or adjacent to bus bar ground plane 70 so as to project outwardly from free edge 75 while being in electrical communication with bus bar ground plane 70. Advantageously, biasable structures 74 resiliently cooperate with conductive edge surface 220 of the printed circuit board to provide electrical and mechanical engagement between bus bar ground plane 70 and conductive grounding planes 214 positioned below opposing top and bottom surfaces 212 and within the printed circuit board. It is significant to the invention that biasable structures 74 or free edge 75, or any nonbiasable structures that engage conductive side surface 220 do so without projecting into or extending through the edge surface of the printed circuit board. It will be understood that nonbiasable means, e.g., a straight, non-protruding edge, or detents, nubs, protrusions or other raised or outwardly projecting structures, may be formed along free edge 75 which may be adequate for electrical and mechanical engagement between bus bar ground plane 70 and a ground plane positioned within the printed circuit board, without projecting into or extending through the edge surface of the printed circuit board.

Second connector housing 18 includes a first or mating surface 120 and an oppositely facing second or terminal receiving surface 122. End walls 124 and side walls 126 extend between mating surface 120 and terminal receiving surface 122. A mating projection 130 extends from mating surface 120 away from terminal receiving surface 122. Mating projection 130 is dimensioned to extend between end walls 124. Terminal receiving cavities 132 are provided in second connector housing 18 and extend from terminal receiving surface 122 to mating surface 120. Terminal receiving cavities 132 are provided on both sides of the longitudinal axis of second connector housing 18. Terminal receiving cavities 132 provided on a respective side of the axis, are mirror images of terminal receiving cavities provided on opposite side of the axis.

Referring to FIG. 5, terminal receiving cavities 132 have dividing walls 134 which separate the terminal receiving cavities into two portions, first leg receiving cavities 136 and second leg receiving cavities 138. Dividing walls 134 have lead-in surfaces 140, 142 which are provided proximate terminal receiving surface 122. Shoulders 144 are provided on dividing walls 134 on surfaces of dividing walls 134 which are positioned proximate second leg receiving cavities 138. Securing projections 146 are also provided in terminal receiving cavities 132. Bus bar receiving recess 148 second connector housing 18. Bus bar receiving recess 148 extends from terminal receiving surface 122 past mating surface 120 through mating projection 130. Second connector terminals 150 (FIG. 5) have mounting portions 152. First legs 154 and second legs 156 extend from mounting portionsl52 in essentially the same direction, thereby enabling first and second legs 154,156 to be mated with the mating connector. Printed circuit board mating legs 158 and stand off legs 159 extend from mounting portions 152 in a direction which is opposed to first and second legs 154,156.

Mounting portions 152 have recesses 160 provided on side surfaces. Recesses 160 cooperate with securing projections 146 to provide the interference fit required to maintain terminals 150 in terminal receiving cavities 132. Terminals 150 have projections 161 which extend from side surfaces. Projections 161 facilitate the interference fit of the terminals. It should be noted that end surfaces of dividing walls 134 also cooperate with surfaces of mounting portions 152 to ensure that terminals 150 are properly positioned.

First legs 154 have a slightly arcuate configuration. The free ends of the first legs have enlarged contact sections 162 which extend beyond first leg receiving cavities 136 and beyond mating surface 120. Enlarged positioning sections 164 are also provided on the first legs 154. The positioning sections 164 cooperate with dividing walls 134 when the first legs are in an unmated condition. It is important to note that first leg receiving cavities 136 are dimensioned to receive first legs 154 thereby allowing the first legs to move from an unmated or slightly prestressed position to a mated position.

Second legs 156 are positioned in second leg receiving cavities 138. Unlike the first legs, second legs 156 do not extend beyond mating surface 120. Free ends 166 of the second legs are provided at an angle relative to the second legs. This allows free ends 166 to engage dividing walls 134. Lead-in surfaces 168 are provided at free ends 166 of second legs 156.

Referring to FIG. 7, bus bar ground plane mating terminals 170 are positioned in second connector housing 18. Bus bar ground plane mating terminals 170 have connector mating portions 172 and circuit board mating pins 174. Connector mating portions 172 have an essentially U-shaped configuration, with enlarged contact projections 176 provided at the free ends thereof. Circuit board mating pins 174 have enlarged securing projections 178 which cooperate with the side walls of receiving recess 148 to maintain the bus bar ground plane mating terminals 170 in the recess.

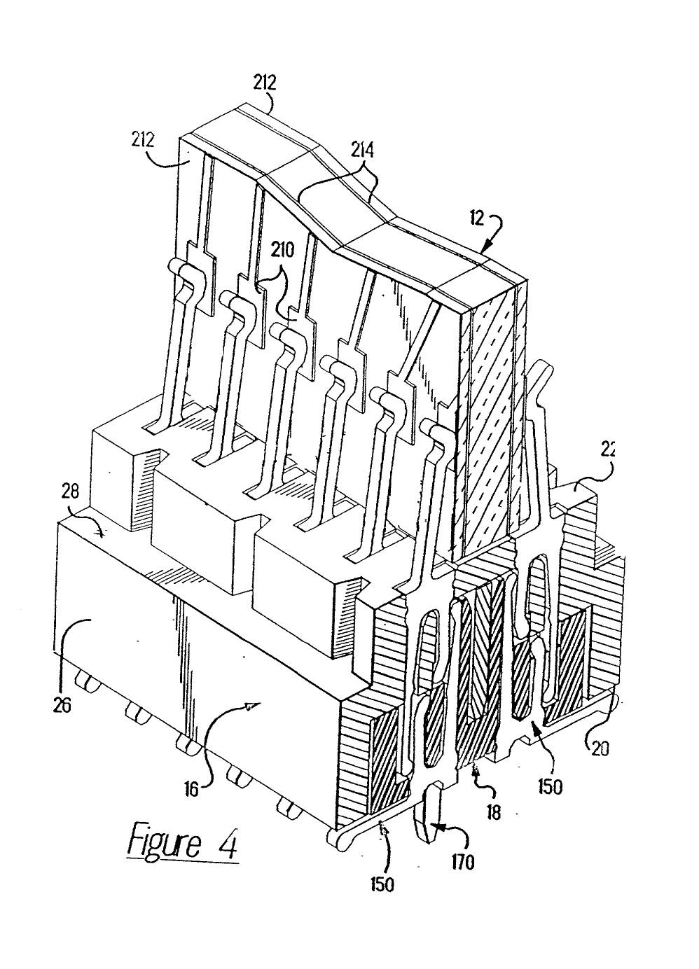

First printed circuit board 12 (FIGS. 1-4) has conductive signal paths 210 provided on the opposing top and bottom surfaces 212. Conductive grounding planes 214 are positioned below opposing top and bottom surfaces 212 (FIG. 3). The conductive grounding planes 214 include conductive edge surfaces 220 that are exposed at the peripheral edge surfaces extending between opposing top and bottom surfaces 212.

Second printed circuit board 14 (FIGS. 1 and 7), has conductive signal paths 230 provided on at least one top or bottom surface 232. Conductive grounding planes (not shown) are positioned below top or bottom surface 232. The conductive grounding planes include conductive edge surfaces 220 that are exposed at the peripheral edge surfaces extending between opposing top and bottom surfaces 232.

In operation, first connector housing 16 is positioned in electrical engagement with first printed circuit board 12. In order to accomplish this electrical connection, a fully assembled first connector housing 16, with bus bars 70 provided therein, is positioned in some type of mounting fixture (not shown). The mounting fixture can be a standard type mounting fixture which is dimensioned to receive first connector housing 16. It is important that the mounting fixture be dimensioned to support bus bars 70 in the housing, as bus bars 70 are only positioned in the housing with an interference fit. First connector housing is positioned in the fixture such that mating legs 58 and circuit board mating pins 74 extend outward.

With first connector housing 16 properly positioned in the fixture, the first connector housing is aligned in coplanar confronting relation with first printed circuit board 12, and then moved into engagement with first printed circuit board 12. In particular, the first connector housing is moved into engagement with the edge surface 220 of printed circuit board 12. As first connector housing 16 and first circuit board 12 are moved into engagement, printed circuit board mating legs 58 engage edge surface 220 of first circuit board 12. It should be noted that the distance provided between the free ends of opposed mating legs 58 is less than the width of the first printed circuit board 12. Consequently, when the printed circuit board mating legs 58 first engage first printed circuit board 12, legs will contact edge surface 220. Upon further insertion of first connector housing 16 onto first printed circuit board 12, legs 58 are force to spread apart and slide over opposing top and bottom surfaces 212. This motion continues until first connector housing 16 is fully inserted onto printed circuit board 12, thereby positioning legs 58 in electrical engagement with conductive signal paths 210. The electrical engagement between legs 58 and conductive signal paths 210 is ensured due since legs 58 are provided in a prestressed position, and consequently provide a significant normal force on the conductive signal paths.

As first connector housing 16 mates with printed circuit board 12, biasable structures 74 also cooperate with first circuit board 12. More particularly, biasable structures 74 engage edge surface 220 of printed circuit board 12 after mating legs 58 have begun sliding over opposing top and bottom surfaces 212. It is important to note that biasable structures 74 must be provided in alignment with the conductive portions of edge surface 220 as the mating occurs. Biasable structures 74 must exert a force on conductive side edge surface 220 to electrically and mechanically engage conductive edge surface of the printed circuit board's ground plane without projecting into or extending through that edge surface in anyway. For example, cantilever springs may be employed as biasable structures 74. In this case, biasable structures 74 would be formed integrally with the edge of bus bar ground plane 70. Alternatively, biasable structures 74 may be a combination of compression spring and contact is arranged on bus bar ground plane 70 so as to project outwardly from a free edge. Advantageously, biasable structures 74 resiliently cooperate with conductive edge surface 220 of printed circuit board 12 to provide electrical and mechanical engagement between bus bar ground plane 70 and a ground plane positioned within printed circuit board 12, without projecting into or extending through edge surface 220 of printed circuit board 12.

With first connector housing 16 fully inserted on first circuit board 12, printed circuit board mating legs 58 are soldered to conductive signal paths 210. This solder connection also acts to maintain printed circuit board 12 in close engagement with first connector housing 16 in opposition to the force applied to conductive edge surface 220 by biasable structure 74. This provides the mechanical and electrical connections required between first connector housing 16 and first printed circuit board 12.

The are several advantages of utilizing a connector which is mounted onto the side surface of a circuit board. First, as the sophistication of equipment increases, more connectors are required to be positioned on circuit boards. As there is a limited amount of space available, solutions must be found to increase the amount of connectors mated to the circuit board. This invention allows the edges or side surfaces of the circuit board to be utilized for the mating of connectors. Also, the placement of the connectors on the side surfaces of the circuit board allows for relatively short path lengths across which the signals travel, thereby minimizing the propagation delay associated with the connector.

With the insertion of the first connector housing 16 onto the first circuit board complete, the fixture can be removed from the housing.

Second connector housing 18 is positioned on second circuit board 14 (FIGS. 1-5). During this process, circuit board mating pins 174 are inserted into openings 238 provided on printed circuit board 14. As pins 174 are inserted into openings 238, printed circuit board mating legs 158 engage conductive signal paths 230 provided on surface 232 of printed circuit board 230. The engagement of legs 158 with paths 230 defines the fully inserted position of second connector housing relative to second circuit board. With the second connector housing fully inserted, pins 174 are soldered in openings 238 and legs 158 are soldered to conductive paths 230. This provides the mechanical and electrical connection required between second connector housing 18 and second circuit board 14. Circuit board mating legs 58,158 have arcuate surfaces provided at their ends. The solder cooperates with the arcuate surface to provide the mechanical and electrical interconnection with the circuit boards. The configuration of the arcuate surfaces helps to insure that the solder will not crack. In other words, the use of mating legs which have flat surfaces promotes the solder to crack, thereby causing an unreliable connection.

With the first and second connector housings 16,18 properly mounted to the circuit boards 12,14, the connector housings are mated together.

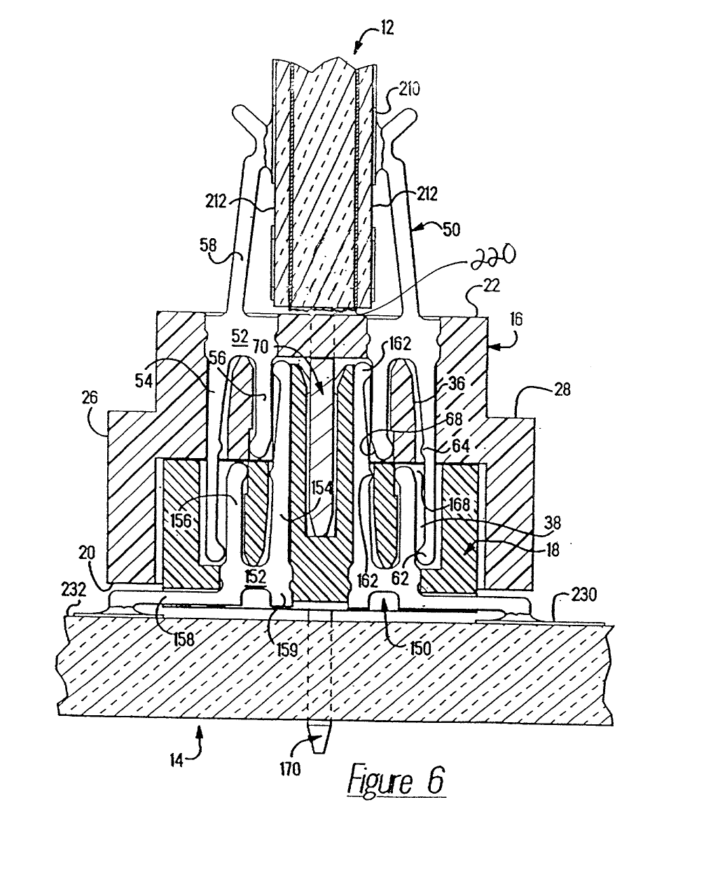

The first connector housing 16 is positioned proximate the second connector housing 18 such that the mating connector receiving recess 30 of the first housing is in alignment with the second connector housing. Mating connector receiving recess 30 is dimensioned to allow second connector housing 18 to be inserted. To mate the connector housings together, the first connector housing 16 is moved from an initial position (FIG. 5) to a final or assembled position (FIG. 6). As the connector housings are moved to the assemble position, first connector terminals 50 engage second connector terminals 150 to provide the electrical connection required.

As the mating occurs, the enlarged contact sections 62 of first legs 54 of first connector terminals 50 engage lead-in surfaces 168 of second legs 156 of second connector terminals 150. At the same time, enlarged contact sections 162 of first legs 154 of second connector terminals 150 engage lead-in surfaces 68 of second legs 56 of first connector terminals 50. Enlarged contact sections 62, 162 are then slide over lead-in surfaces 168,68, thereby positioning enlarged contact sections 62,162 on side surfaces of second legs 156, 56. Several functions are performed by the lead-in surfaces. The lead-in surfaces compensate for any slight misalignment of the terminals when mating occurs. The lead-in surfaces also cause first legs 54,154 to be moved to a stressed position, such that enlarged contact sections 62, 162 will provide a significant normal force on second legs 156, 56 when the contact sections are slid over the second legs.

As the mating of the connectors continues, enlarged contact sections 62,162 will be slid on the side surfaces of second legs 156, 56 to fully assembled position (FIG. 6). This sliding engagement of the enlarged contact sections provides a wiping action under significant normal force conditions, thereby helping to ensure for a positive electrical connection between enlarged contact sections 62,162 and second legs 156, 56. It should be noted that as enlarged contact sections 62, 162 of first legs 54, 154 are slid over second legs 156, 56, walls of the housings prevent first legs 54, 154 from taking a permanent set. In other words, the walls of the housings are provided in close proximity to first legs 54, 154, thereby insuring that the first legs can not be deformed beyond their elastic limit. This type of terminal configuration allows for a connector which requires a minimal height for operation. As the entire length of first legs 54, 154 are used for a resilient beam, the overall height of the connector can be minimized. In other words, the stationary portions of the terminals are provided on the second legs of the terminals, which is physically distinct from the first legs. Consequently, as no stationary portions are required on the first legs, the overall height of the first legs is minimized. It is also important to note that second legs 56, 156 are used only as stationary members, i.e. no resilient characteristics are required. Consequently, the second legs can be secured in the housings and be used to stabilize the terminals in the housings.

The configuration of the terminals also provides for a reliable electrical connection. Each terminal provides two parallel paths over which the signal can travel. This provides for a redundant electrical connection, and results in a self inductance which is approximately half of that of a terminal with a single path. This is particularly advantageous in high speed applications.

As the connector housings are mated together, bus bars 70 are positioned the bus bar mating terminals 170 (FIG. 7). The spacing between enlarged contact projections 176 of bus bar mating terminals 170 is less than the width of bus bars 70. Consequently, the positioning of bus bars 70 in bus bar mating terminals 170 causes the contact projections to be spread apart, which in turn causes contact projections 176 to exert the normal force required on bus bars 70.

With the connector housing mated together effective electrical connection is provided between first circuit board 12 and second circuit board 14. The connection is provided utilizing minimal space, as the first connector housing is mated to the edge and top and bottom surfaces of first circuit board. This is of great benefit, particularly as board real estate is at a premium.

Although the connector assembly described provides an electrical connection between two printed circuit boards, the principal of the invention can be utilized in other types of connector assemblies, i.e a cable to board connector assembly.

It is to be understood that the present invention is by no means limited only to the particular constructions herein disclosed and shown in the drawings, but also comprises any modifications or equivalents within the scope of the claims.

What is claimed is:

1. A connector assembly comprising signal contacts and a ground plane mounted within a housing wherein said ground plane includes a plurality of electrical contacts positioned along one edge and arranged so as to electrically engage only a conductive edge surface of a printed circuit board ground plane.

2. A connector assembly having a housing with first and second terminals extending therefrom, the first and second terminals have respectively first and second mating portions which cooperate with a printed circuit board provided proximate the housing, the printed circuit board having conductive areas provided on surfaces and conductive edges which extend between the surfaces wherein:
said first terminals are secured in the housing, first mounting portions of the first terminals are located in first terminal receiving cavities of the housing, the first mating portions comprise legs that are integral with the first mounting portions and extend outside the housing, the legs cooperate with the conductive areas provided on the printed circuit board for surface mounting; and
said second terminals are secured in the housing, the second mating portions comprise biasable structures that extend outside the housing, the biasable structures electrically and mechanically engage only the surface of a conductive edge surface of a printed circuit board ground plane.

3. A connector assembly according claim 2 wherein said second mating portions comprise electrical contacts that extend outside the housing, the contacts electrically and mechanically engage an edge surface of the printed circuit board to cooperate with a conductive edge portion provided on the printed circuit board.

4. A connector assembly according claim 2 wherein said second mating portions comprise protrusions that extend outside the housing, the protrusions formed on the edge of the second terminal so as to electrically and mechanically engage an edge surface of the printed circuit board to cooperate with a conductive edge portion provided on the printed circuit board.

5. A connector assembly according claim 1 having a connector housing with first terminals and at least one bus bar ground plane extending therefrom, the first terminals and at least one bus bar ground plane have respectively first and second mating portions which cooperate with a printed circuit board provided proximate the housing, the printed circuit board having conductive areas provided on surfaces and conductive edges which extend between the surfaces wherein:
said first terminals are secured in the housing, first mounting portions of the first terminals are located in first terminal receiving cavities of the housing, the first mating portions comprise legs that are integral with the first mounting portions and extend outside the housing, the legs cooperate with the conductive areas provided on the printed circuit board for surface mounting; and
said at least one bus bar ground plane being secured in the housing, the second mating portions comprise contact portions, including biasable means comprising at least one of spring members and nonbiasable protrusions that extend outside the housing and along a free edge of the at least one bus bar ground plane, the contact portions electrically and mechanically engage an edge surface of the printed circuit board to cooperate with a conductive edge portion provided on the printed circuit board.

6. A connector assembly according claim 1 further comprising signal contacts and a ground plane wherein the ground plane includes a plurality of nonbiasable contact means positioned along one edge and adapted to cooperatively engage the conductive edge surface of a printed circuit board ground plane without penetrating or extending into the edge of the printed circuit board.

7. A connector assembly according claim 6 wherein said means comprise a plurality of spring contacts projecting outwardly from one edge and adapted to cooperatively engage the conductive edge surface of a printed circuit board ground plane without penetrating or extending into the edge of the printed circuit board.

8. A connector assembly according claim 6 wherein said means comprise a plurality of spring contact assemblies each having a contact terminal projecting outwardly from one edge and adapted to cooperatively engage the conductive edge surface of a printed circuit board ground plane without penetrating or extending into the edge of the printed circuit board.

9. An electrical circuit assembly comprising:
a printed circuit board having at least one conductive grounding plane positioned below opposing top and bottom surfaces, said at least one conductive grounding plane electrically communicating with at least one conductive edge surface that is accessible at a peripheral edge surface that extends between said opposing top and bottom surfaces; and
a connector comprising signal contacts and a ground plane mounted within a housing wherein said ground plane includes a plurality of spring contacts positioned along one edge and arranged so as to electrically engage said at least one conductive edge surface of said at least one conductive grounding plane.

10. An electrical circuit assembly according claim 9 wherein said plurality of spring contacts comprise electrical contacts that extend outside the housing so that the contacts electrically and mechanically engage only the surface of said at least one conductive edge surface of said printed circuit board.

11. An electrical circuit assembly according claim 9 wherein said ground plane includes protrusions that extend outside said housing, said protrusions being formed so as to electrically and mechanically engage only the surface of said at least one conductive edge surface of said printed circuit board.

12. An electrical circuit assembly according claim 9 wherein said connector housing comprises first terminals and at least one bus bar ground plane extending therefrom, the first terminals and at least one bus bar ground plane have respectively first and second mating portions which cooperate with said printed circuit board provided proximate said housing, said printed circuit board having conductive areas provided on surfaces and conductive edges which extend between the surfaces wherein:
said first terminals are secured in the housing, first mounting portions of the first terminals are located in first terminal receiving cavities of the housing, the first mating portions comprise legs that are integral with the first mounting portions and extend outside the housing, the legs cooperate with the conductive areas provided on the printed circuit board for surface mounting; and
said at least one bus bar ground plane being secured in the housing, the second mating portions comprise contact portions, including biasable means comprising at least one of spring members and nonbiasable protrusions that extend outside the housing and along a free edge of the at least one bus bar ground plane, the contact portions electrically and mechanically engage an edge surface of the printed circuit board to cooperate with a conductive edge portion provided on the printed circuit board.

13. An electrical circuit assembly according claim 9 wherein said connector ground plane includes a plurality of non biasable contact means positioned along one edge so as to electrically and mechanically engage only the surface of said at least one conductive edge surface of said printed circuit board.

14. An electrical circuit assembly according claim 12 wherein said means comprise a plurality of resilient contacts projecting outwardly from one edge and adapted to cooperatively engage the conductive edge surface of a printed circuit board ground plane without penetrating or extending into the edge of the printed circuit board.

15. An electrical circuit assembly according claim 12 wherein said means comprise a plurality of resilient electrical contact assemblies each having a terminal projecting outwardly from one edge so as to engage only the conductive edge surface of a printed circuit board ground plane without penetrating into the edge surface of the printed circuit board.
